(19) United States
(12) Patent Application Publication
(10) Pub. No.: US 2022/0237529 A1
(43) Pub. Date: Jul. 28, 2022

(54) METHOD, ELECTRONIC DEVICE AND STORAGE MEDIUM FOR DETERMINING STATUS OF TRAJECTORY POINT

(71) Applicant: BEIJING BAIDU NETCOM SCIENCE TECHNOLOGY CO., LTD., Beijing (CN)

(72) Inventor: Xin ZHANG, BEIJING (CN)

(21) Appl. No.: 17/720,638

(22) Filed: Apr. 14, 2022

(30) Foreign Application Priority Data
Sep. 18, 2021 (CN) 202111110906.5

(51) Int. Cl. G06Q 10/04; G06F 16/29; G06N 3/08

(52) U.S. Cl. CPC G06Q 10/04; G06N 3/08; G06F 16/29

(57) ABSTRACT

A method for determining a status of a trajectory point is provided. The present disclosure relates to the field of artificial intelligence, and in particular to the field of intelligent transportation. An implementation is: obtaining a plurality of trajectory points based on trajectory data, where the trajectory data is obtained based on a positioning system; extracting a trajectory feature and a geographical environment feature of each of the plurality of trajectory points to obtain a plurality of feature vectors corresponding to the plurality of trajectory points; and determining a status of each trajectory point in the plurality of trajectory points based on the plurality of feature vectors.

### CROSS REFERENCE TO RELATED APPLICATIONS

This application claims priority to Chinese Patent Application No. 202111110906.5, filed on Sep. 18, 2021, the contents of which are hereby incorporated by reference in their entirety for all purposes.

### TECHNICAL FIELD

The present disclosure relates to the field of artificial intelligence, in particular to the field of intelligent transportation, and specifically to a method and an apparatus for determining a status of a trajectory point, an electronic device, a computer-readable storage medium, and a computer program product.

### BACKGROUND

When semantic understanding is performed based on trajectories of a vehicle and people, recognition of a status of a trajectory point is a quite important basic function. During most advanced trajectory analyses such as trajectory classification, transportation means recognition, and travel intention recognition, recognition of a trajectory stop point is always the first step. Inaccuracy of the recognition of the status of the trajectory point may affect accuracy of all subsequent analyses that are performed based on the status of the trajectory point.

The method described in this section is not necessarily a method that has been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a method, an electronic device and a computer-readable storage medium for determining a status of a trajectory point.

According to an aspect of the present disclosure, a method for determining a status of a trajectory point is provided, the method including: obtaining a plurality of trajectory points based on trajectory data, where the trajectory data is obtained based on a positioning system; extracting a trajectory feature and a geographical environment feature of each of the plurality of trajectory points to obtain a plurality of feature vectors corresponding to the plurality of trajectory points; and determining a status of each trajectory point in the plurality of trajectory points based on the plurality of feature vectors.

According to an aspect of the present disclosure, a method for training a sequence model for determining a status of a trajectory point is provided, the method including: obtaining a plurality of groups of corresponding sample trajectory point data based on a plurality of groups of sample trajectory data, where each group of sample trajectory point data in the plurality of groups of sample trajectory point data includes a plurality of sample trajectory points, a plurality of sample statuses in a one-to-one correspondence to the plurality of sample trajectory points, and a plurality of sample feature vectors in a one-to-one correspondence to the plurality of sample trajectory points, and where each sample feature vector in the plurality of sample feature vectors represents a trajectory feature and a geographical environment feature of a corresponding sample trajectory point; for each group of sample trajectory point data in the plurality of groups of sample trajectory point data: inputting the plurality of sample feature vectors in a one-to-one correspondence to the plurality of sample trajectory points in the group of sample trajectory point data to a sequence model to obtain a predicted status of each sample trajectory point in the plurality of sample trajectory points output by the sequence model; and calculating, based on the plurality of sample statuses, a loss function value corresponding to the group of sample trajectory point data; and adjusting parameters of the sequence model based on a plurality of loss function values corresponding to the plurality of groups of sample trajectory point data.

According to another aspect of the present disclosure, an electronic device is provided, including: at least one processor; and a memory communicatively connected to the at least one processor, where the memory stores instructions executable by the at least one processor, and when executed by the at least one processor, the instructions cause the at least one processor to perform the foregoing method.

According to another aspect of the present disclosure, a non-transitory computer-readable storage medium storing computer instructions is provided, where the computer instructions are used to cause the computer to perform the foregoing method.

According to one or more embodiments of the present disclosure, the present disclosure combines the trajectory feature and the geographical environment feature of the trajectory point, and the deep learning model is used to determine the status of the trajectory point, thereby improving accuracy of recognition of the status of the trajectory point. It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTIONS OF THE DRAWINGS

The drawings show embodiments and form a part of the specification, and are used to explain example implementations of the embodiments together with a written description of the specification. The embodiments shown are merely for illustrative purposes and do not limit the scope of the claims. Throughout the drawings, identical reference signs denote similar but not necessarily identical elements.

FIG. 1 is a flowchart of a method for determining a status of a trajectory point according to an example embodiment of the present disclosure;

FIG. 2 is a flowchart of a method for training a sequence model for determining a status of a trajectory point according to an example embodiment of the present disclosure;

FIG. 3 is a structural block diagram of an apparatus for determining a status of a trajectory point according to an example embodiment of the present disclosure;

FIG. 4 is a structural block diagram of an apparatus for training a sequence model for determining a status of a trajectory point according to an example embodiment of the present disclosure; and

FIG. 5 is a structural block diagram of an example electronic device that can be used to implement an embodiment of the present disclosure.

### DETAILED DESCRIPTION

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

In the related art, it is generally considered that trajectory stop points are aggregated to some extent. With such a characteristic, clustering is performed based on spatial and temporal features such as speed and distance features of trajectory points, so that trajectory points with a distance less than a specific threshold are aggregated into clusters, where each cluster is one set of trajectory stop points. In this way, a stop state of a trajectory point is determined. However, this method has quite low accuracy for recognizing the status of the trajectory point and has many recognition errors for a slow moving state such as walking. In addition, whether the trajectory point is in a stop state or a moving state is defined differently in different scenarios. The foregoing method cannot determine whether the trajectory point stops passively or actively in a scenario of waiting for traffic lights at a crossroads or in a scenario of a traffic jam.

To solve one or more of the foregoing problems, the present disclosure combines a trajectory feature and a geographical environment feature of the trajectory point, and a deep learning model is used to learn depth features of a trajectory point sequence and determine the status of the trajectory point, thereby improving accuracy of recognition of the status of the trajectory point.

The following further describes a method for determining a status of a trajectory point in the present disclosure with reference to the accompanying drawings.

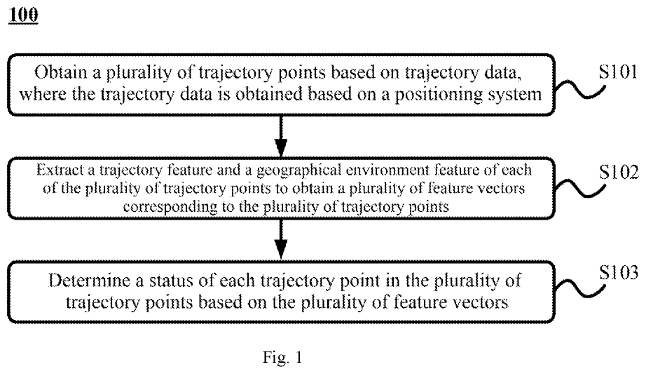

FIG. 1 is a flowchart of a method for determining a status of a trajectory point according to an example embodiment of the present disclosure.

As shown in FIG. 1, the method 100 for determining a status of a trajectory point may include: step S101: obtaining a plurality of trajectory points based on trajectory data, where the trajectory data is obtained based on a positioning system; step S102: extracting a trajectory feature and a geographical environment feature of each of the plurality of trajectory points to obtain a plurality of feature vectors corresponding to the plurality of trajectory points; and step S103: determining a status of each trajectory point in the plurality of trajectory points based on the plurality of feature vectors.

In this case, the trajectory feature and the geographical environment feature of the trajectory point are combined to determine the status of the trajectory point. On the basis of the trajectory feature, the geographical environment feature is added for multi-dimensional description of the trajectory point, information about an environment where the trajectory point is located is fused, and an environment factor is fully considered when the status of the trajectory point is determined. In some scenarios, for example, in a traffic jam or when vehicles move slowly, recognition errors may be easily caused when the status of the trajectory point is determined only based on a speed of the trajectory point in the trajectory feature. The recognition errors caused by depending on only the trajectory feature can be reduced by combining the trajectory feature and the geographical environment feature of the trajectory point, for example, by extracting the feature that a road where the trajectory point is located is being jammed, so that accuracy of the recognition of the status of the trajectory point in different environments and different scenarios is improved.

According to some embodiments, in step S101, the trajectory data obtained based on the positioning system is denoised first, and then a trajectory is cut into a plurality of sections at equal intervals to obtain a plurality of trajectory points.

According to some embodiments, the trajectory feature includes: a longitude, a latitude, and a timestamp of the corresponding trajectory point. In this case, information such as a speed of each trajectory point and a distance between the trajectory points may be calculated based on trajectory features of the plurality of trajectory points to describe a time sequence among the plurality of trajectory points and the statuses of the trajectory points. In some embodiments, speed and distance data calculated based on the information about the longitude, the latitude, and the timestamp of the trajectory point may also form a part of the trajectory feature to determine the status of the trajectory point.

According to some embodiments, the geographical environment feature includes at least one of the following: information about a building where the corresponding trajectory point is located and information about a road where the corresponding trajectory point is located.

In an example embodiment, the information about a building where the corresponding trajectory point is located may include: whether the corresponding trajectory point is located indoors or outdoors and distribution categories of points of interest around the corresponding trajectory point. In some embodiments, whether the trajectory point is located indoors or outdoors may be determined based on a reverse geocoding technology for a map, where two cases thereof are marked as 0 and 1 respectively. Due to positioning errors, a boundary of the building may be expanded to some extent, improving precision of the foregoing determination. The distribution categories of points of interest around the trajectory point may be correspondingly mapped to number information by using a word vector algorithm.

In an example embodiment, the information about a road where the corresponding trajectory point is located may include: whether the corresponding trajectory point is on a road, a grade of the road where the corresponding trajectory point is located, a road condition of the road where the corresponding trajectory point is located, and whether the corresponding trajectory point is near a crossroads.

In an example embodiment, road matching may be performed on trajectory data by using a hidden Markov model (HMM) to determine the information about the road where the trajectory point is located: determining whether the corresponding trajectory point is on a road, where two cases thereof are marked as 0 and 1 respectively; determining a grade of the road where the corresponding trajectory point is located, with numbers for representing roads of different grades such as national highway, urban highway, national road, and provisional road; and determining a road condition of the road where the corresponding trajectory point is located, with numbers for grading how serious the road is jammed. In addition, whether the corresponding trajectory point is near a crossroads may be determined by using the reverse geocoding technology for a map, where two cases thereof are marked as 0 and 1 respectively.

In this case, in the foregoing several example embodiments, the building information and the road information included in the geographical environment feature of the trajectory point may be extracted and respectively mapped to numbers to subsequently form the feature vector of the trajectory point.

According to some embodiments, step S102 includes: extracting a trajectory feature and a geographical environment feature of each trajectory point in the plurality of trajectory points; and splicing the trajectory feature and the geographical environment feature of the trajectory point to obtain the feature vector of the trajectory point.

It can be understood that in step S102, the trajectory feature and the geographical environment feature of the trajectory point are separately extracted and correspondingly mapped to numbers, and then spliced into the multi-dimensional feature vector that integrates the trajectory feature and the geographical environment feature. The foregoing process is repeated for each trajectory point in the plurality of trajectory points to obtain the plurality of feature vectors in a one-to-one correspondence to the plurality of trajectory points. In this case, on the basis of the trajectory feature, the geographical environment feature is added for further description of the trajectory point, information about an environment where the trajectory point is located is fused, and an environment factor is fully considered when the status of the trajectory point is determined.

According to some embodiments, step S103 includes: inputting the plurality of feature vectors corresponding to the plurality of trajectory points to a trained deep learning model to obtain a plurality of detection results output by the deep learning model, where the plurality of detection results represents a status of each trajectory point in the plurality of trajectory points, and where the deep learning model is a sequence model.

It can be understood that the sequence model performs well when deeply learning sequence features, and the sequence model can fully learn and mine a time sequence of the trajectory and an association between the trajectory points when learning the sequence features of the plurality of trajectory points, thereby improving accuracy of recognition of the status of the trajectory point.

According to some embodiments, the sequence model includes one of the following: a gated recurrent unit (GRU), a long short-term memory (LSTM), and a bi-directional long short-term memory (BiLSTM).

According to some embodiments, the status of the trajectory point includes any one of the following: an active stop state, a passive stop state, and a non-stop state. Given that classifying the status of the trajectory point into a stop state and a non-stop state cannot express the real state of the trajectory point in many scenarios, for example, in a scenario of waiting for traffic lights at a crossroads or in a scenario of a heavy traffic jam, in such scenarios, the stop state is further classified into an active stop state and a passive stop state, so that the status of the trajectory point can be more detailed and accurately described. Therefore, more classifications of the status of the trajectory point can improve accuracy of recognition of the stop point in different scenarios.

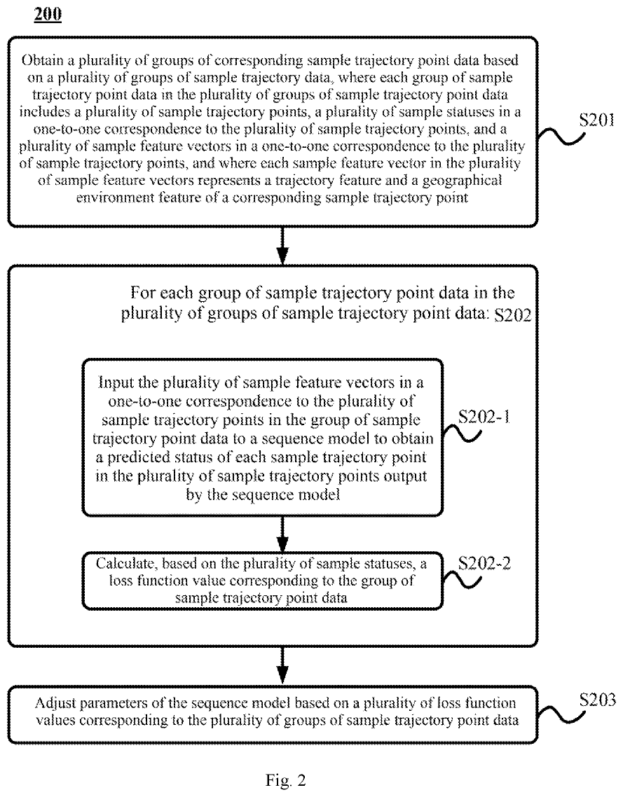

According to another aspect of the present disclosure, a method for training a sequence model for determining a status of a trajectory point is provided. As shown in FIG. 2, the method 200 for training a sequence model for determining a status of a trajectory point includes: step S201: obtaining a plurality of groups of corresponding sample trajectory point data based on a plurality of groups of sample trajectory data, where each group of sample trajectory point data in the plurality of groups of sample trajectory point data includes a plurality of sample trajectory points, a plurality of sample statuses in a one-to-one correspondence to the plurality of sample trajectory points, and a plurality of sample feature vectors in a one-to-one correspondence to the plurality of sample trajectory points, and where each sample feature vector in the plurality of sample feature vectors represents a trajectory feature and a geographical environment feature of a corresponding sample trajectory point; step S202: for each group of sample trajectory point data in the plurality of groups of sample trajectory point data: step S202-1: inputting the plurality of sample feature vectors in a one-to-one correspondence to the plurality of sample trajectory points in the group of sample trajectory point data to a sequence model to obtain a predicted status of each sample trajectory point in the plurality of sample trajectory points output by the sequence model; and step S202-2: calculating, based on the plurality of sample statuses, a loss function value corresponding to the group of sample trajectory point data; and step S203: adjusting parameters of the sequence model based on a plurality of loss function values corresponding to the plurality of groups of sample trajectory point data.

In this case, the trained sequence model can learn the sequence features of the plurality of trajectory points to determine the status of the trajectory point.

According to some embodiments, sample trajectory data may be generated by using a self-made annotation tool. The tool generates one trajectory point per second and uploads a status corresponding to the point to a backend. With this tool, a user may select a corresponding state based on its current state, and trajectory points between state switching is marked by the state before switching, so that annotated sample trajectory point data is obtained to train the model and verify the effects. In addition, some clear trajectories for driving, walking, riding, public transport, and parking that are obtained from a map application in batches may also be used to further enhance sample data to obtain massive annotated sample trajectory data.

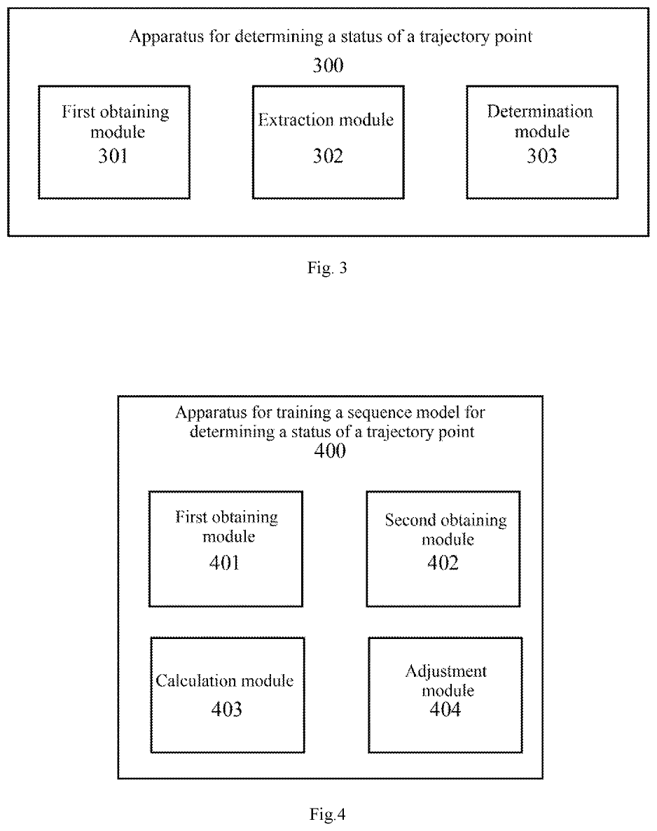

According to another aspect of the present disclosure, an apparatus for determining a status of a trajectory point is provided. As shown in FIG. 3, the apparatus 300 for determining a status of a trajectory point includes: a first obtaining module 301 configured to obtain a plurality of trajectory points based on trajectory data, where the trajectory data is obtained based on a positioning system; an extraction module 302 configured to extract a trajectory feature and a geographical environment feature of each of the plurality of trajectory points to obtain a plurality of feature vectors corresponding to the plurality of trajectory points; and a determination module 303 configured to determine a status of each trajectory point in the plurality of trajectory points based on the plurality of feature vectors.

In this case, the trajectory feature and the geographical environment feature of the trajectory point are combined, and a deep learning model is used to learn depth features of a trajectory point sequence and determine the status of the trajectory point, thereby improving accuracy of recognition of the status of the trajectory point.

According to some embodiments, the first obtaining module 301 is further configured to: denoise the trajectory data obtained based on the positioning system, and cut a trajectory into a plurality of sections at equal intervals to obtain a plurality of trajectory points.

According to some embodiments, the trajectory feature includes: a longitude, a latitude, and a timestamp of the corresponding trajectory point. In this case, information such as a speed of each trajectory point and a distance between the trajectory points may be calculated by the extraction module 302 based on trajectory features of the plurality of trajectory points to describe a time sequence among the plurality of trajectory points and the statuses of the trajectory points. In some embodiments, speed and distance data calculated based on the information about the longitude, the latitude, and the timestamp of the trajectory point may also be used by the extraction module 302 to form a part of the trajectory feature to determine the status of the trajectory point.

According to some embodiments, the geographical environment feature includes at least one of the following: information about a building where the corresponding trajectory point is located and information about a road where the corresponding trajectory point is located.

In an example embodiment, the information about a building where the corresponding trajectory point is located may include: whether the corresponding trajectory point is located indoors or outdoors and distribution categories of points of interest around the corresponding trajectory point. In some embodiments, whether the trajectory point is located indoors or outdoors may be determined by the extraction module 302 based on a reverse geocoding technology for a map, where two cases thereof are marked as 0 and 1 respectively. Due to positioning errors, a boundary of the building may be expanded to some extent, improving precision of the foregoing determination. The distribution categories of points of interest around the trajectory point may be correspondingly mapped to number information by the extraction module 302 by using a word vector algorithm.

In an example embodiment, the information about a road where the corresponding trajectory point is located may include: whether the corresponding trajectory point is on a road, a grade of the road where the corresponding trajectory point is located, a road condition of the road where the corresponding trajectory point is located, and whether the corresponding trajectory point is near a crossroads.

In an example embodiment, road matching may be performed on trajectory data by the extraction module 302 by using a hidden Markov model (HMM) to determine the information about the road where the trajectory point is located: determining whether the corresponding trajectory point is on a road, where two cases thereof are marked as 0 and 1 respectively; determining a grade of the road where the corresponding trajectory point is located, with numbers for representing roads of different grades such as national highway, urban highway, national road, and provisional road; and determining a road condition of the road where the corresponding trajectory point is located, with numbers for grading how serious the road is jammed. In addition, whether the corresponding trajectory point is near a crossroads may be determined by the extraction module 302 by using the reverse geocoding technology for a map, where two cases thereof are marked as 0 and 1 respectively.

In this case, in the foregoing several example embodiments, the building information and the road information included in the geographical environment feature of the trajectory point may be extracted and respectively mapped to numbers by the extraction module 302 to subsequently form the feature vector of the trajectory point.

According to some embodiments, the extraction module 302 includes: an extraction unit configured to extract a trajectory feature and a geographical environment feature of each trajectory point in the plurality of trajectory points; and a splicing unit configured to splice the trajectory feature and the geographical environment feature of the trajectory point to obtain the feature vector of the trajectory point.

It can be understood that the trajectory feature and the geographical environment feature of the trajectory point are separately extracted and correspondingly mapped to numbers by the extraction unit, and then spliced by the splicing unit into the multi-dimensional feature vector that integrates the trajectory feature and the geographical environment feature. In this case, on the basis of the trajectory feature, the geographical environment feature is added for further description of the trajectory point, information about an environment where the trajectory point is located is fused, and an environment factor is fully considered when the status of the trajectory point is determined.

According to some embodiments, the determination module 303 is further configured to: input the plurality of feature vectors corresponding to the plurality of trajectory points to a trained deep learning model to obtain a plurality of detection results output by the deep learning model, where the plurality of detection results represent a status of each trajectory point in the plurality of trajectory points, and where the deep learning model is a sequence model.

It can be understood that the sequence model performs well when deeply learning sequence features, and the sequence model can fully learn and mine a time sequence of the trajectory and an association between the trajectory points when learning the sequence features of the plurality of trajectory points, thereby improving accuracy of recognition of the status of the trajectory point.

According to some embodiments, the sequence model includes one of the following: a gated recurrent unit (GRU), a long short-term memory (LSTM), and a bi-directional long short-term memory (BiLSTM).

According to some embodiments, the status of the trajectory point includes any one of the following: an active stop state, a passive stop state, and a non-stop state. Given that classifying the status of the trajectory point into a stop state and a non-stop state cannot express the real state of the trajectory point in many scenarios, for example, in a scenario of waiting for traffic lights at a crossroads or in a scenario of a heavy traffic jam, in these scenarios, the stop state is further classified into an active stop state and a passive stop state, so that the status of the trajectory point can be more detailed and accurately described. Therefore, more classifications of the status of the trajectory point performed by the determination module 303 can improve accuracy of recognition of the stop point in different scenarios.

According to another aspect of the present disclosure an apparatus for training a sequence model for determining a status of a trajectory point is further provided. As shown in FIG. 4, the apparatus 400 for training a sequence model for determining a status of a trajectory point includes: a first obtaining module 401 configured to obtain a plurality of groups of corresponding sample trajectory point data based on a plurality of groups of sample trajectory data, where each group of sample trajectory point data in the plurality of groups of sample trajectory point data includes a plurality of sample trajectory points, a plurality of sample statuses in a one-to-one correspondence to the plurality of sample trajectory points, and a plurality of sample feature vectors in a one-to-one correspondence to the plurality of sample trajectory points, and where each sample feature vector in the plurality of sample feature vectors represents a trajectory feature and a geographical environment feature of a corresponding sample trajectory point; a second obtaining module 402 configured to: for each group of sample trajectory point data in the plurality of groups of sample trajectory point data, input the plurality of sample feature vectors in a one-to-one correspondence to the plurality of sample trajectory points in the group of sample trajectory point data to a sequence model to obtain a predicted status of each sample trajectory point in the plurality of sample trajectory points output by the sequence model; a calculation module 403 configured to calculate, based on the plurality of sample statuses, a loss function value corresponding to the group of sample trajectory point data; and an adjustment module 404 configured to adjust parameters of the sequence model based on a plurality of loss function values corresponding to the plurality of groups of sample trajectory point data.

Operations of the modules 401 to 404 of the apparatus 400 for training a sequence model for determining a status of a trajectory point are similar to operations of steps S201 to S203 described above. Details are not described herein again.

According to another aspect of the present disclosure, an electronic device is further provided, including: at least one processor; and a memory communicatively connected to the at least one processor, where the memory stores instructions executable by the at least one processor, and when executed by the at least one processor, the instructions cause the at least one processor to perform any one of the foregoing methods.

According to another aspect of the present disclosure, a non-transitory computer-readable storage medium storing computer instructions is further provided, where the computer instructions are used to cause the computer to perform any one of the foregoing methods.

According to another aspect of the present disclosure, a computer program product is further provided, including a computer program, where when the computer program is executed by a processor, any one of the foregoing methods is implemented.

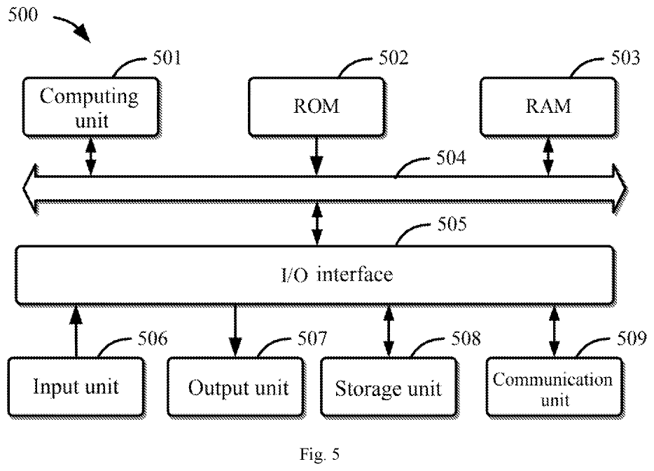

Referring to FIG. 5, a structural block diagram of an electronic device 500 that can serve as a server of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The components shown herein, their connections and relationships, and their functions are merely examples, and are not intended to limit the implementation of the present disclosure described and/or required herein.

As shown in FIG. 5, the device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of entering information to the device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 1302.11 device, a Wi-Fi device, a WiMAX device, a cellular communication device, and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method for determining a status of a trajectory point. For example, in some embodiments, the method for determining a status of a trajectory point may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded onto the RAM 503 and executed by the computing unit 501, one or more steps of the method described above can be performed. Alternatively, in other embodiments, the computing unit 501 may be configured, by any other suitable means (for example, by means of firmware), to perform the method for determining a status of a trajectory point.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems, and devices described above are merely example embodiments or examples, and the scope of the present disclosure is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method for determining a status of one or more trajectory points, the method comprising:
obtaining a plurality of trajectory points based on trajectory data, wherein the trajectory data is obtained based on a positioning system;
extracting a trajectory feature and a geographical environment feature of each trajectory point of the plurality of trajectory points to obtain a plurality of feature vectors corresponding to the plurality of trajectory points; and
determining a status of each trajectory point in the plurality of trajectory points based on the plurality of feature vectors.

2. The method according to claim 1, wherein the extracting the trajectory feature and the geographical environment feature of each trajectory point of the plurality of trajectory points to obtain the plurality of feature vectors corresponding to the plurality of trajectory points comprises:
splicing the trajectory feature and the geographical environment feature of the trajectory point to obtain the feature vector of the trajectory point.

3. The method according to claim 1, wherein the determining the status of each trajectory point in the plurality of trajectory points based on the plurality of feature vectors comprises:
inputting the plurality of feature vectors corresponding to the plurality of trajectory points to a trained deep learning model to obtain a plurality of detection results output by the deep learning model, wherein the plurality of detection results represents a status of each trajectory point in the plurality of trajectory points, and wherein the deep learning model is a sequence model.

4. The method according to claim 1, wherein the trajectory feature of a given trajectory point comprises:
a longitude, a latitude, and a timestamp of the given trajectory point.

5. The method according to claim 1, wherein the geographical environment feature of a given trajectory point comprises at least one of the following:
information about a building where the given trajectory point is located or information about a road where the given trajectory point is located.

6. The method according to claim 3, wherein the sequence model comprises one of the following:
a gated recurrent unit (GRU), a long short-term memory (LSTM), or a bi-directional long short-term memory (BiLSTM).

7. The method according to claim 1, wherein the status of a given trajectory point comprises at least one of the following:
an active stop state, a passive stop state, or a non-stop state of the given trajectory point.

8. A method for training a sequence model for determining a status of one or more trajectory points, the method comprising:
obtaining trajectory point data based on a plurality of groups of sample trajectory point data, wherein each group of sample trajectory point data in the plurality of groups of sample trajectory point data comprises a plurality of sample trajectory points, a plurality of sample statuses in a one-to-one correspondence to the plurality of sample trajectory points, and a plurality of sample feature vectors in a one-to-one correspondence to the plurality of sample trajectory points, and wherein each sample feature vector in the plurality of sample feature vectors represents a trajectory feature and a geographical environment feature of a corresponding sample trajectory point;
for each group of sample trajectory point data in the plurality of groups of sample trajectory point data:
inputting the plurality of sample feature vectors in a one-to-one correspondence to the plurality of sample trajectory points in the group of sample trajectory point data to a sequence model to obtain a predicted status of each sample trajectory point in the plurality of sample trajectory points output by the sequence model; and
calculating, based on the plurality of sample statuses, a loss function value corresponding to the group of sample trajectory point data; and
adjusting parameters of the sequence model based on a plurality of loss function values corresponding to the plurality of groups of sample trajectory point data.

9. An electronic device, comprising:
at least one processor; and
a memory communicatively connected to the at least one processor, wherein the memory stores instructions executable by the at least one processor, and when executed by the at least one processor, the instructions cause the at least one processor to perform operations comprising:
obtaining a plurality of trajectory points based on trajectory data, wherein the trajectory data is obtained based on a positioning system;
extracting a trajectory feature and a geographical environment feature of each trajectory point of the plurality of trajectory points to obtain a plurality of feature vectors corresponding to the plurality of trajectory points; and
determining a status of each trajectory point in the plurality of trajectory points based on the plurality of feature vectors.

10. The electronic device according to claim 9, wherein the extracting the trajectory feature and the geographical environment feature of each trajectory point of the plurality of trajectory points to obtain the plurality of feature vectors corresponding to the plurality of trajectory points comprises:
splicing the trajectory feature and the geographical environment feature of the trajectory point to obtain the feature vector of the trajectory point.

11. The electronic device according to claim 9, wherein the determining the status of each trajectory point in the plurality of trajectory points based on the plurality of feature vectors comprises:
inputting the plurality of feature vectors corresponding to the plurality of trajectory points to a trained deep learning model to obtain a plurality of detection results output by the deep learning model, wherein the plurality of detection results represents a status of each trajectory point in the plurality of trajectory points, and wherein the deep learning model is a sequence model.

12. The electronic device according to claim 9, wherein the trajectory feature of a given trajectory point comprises:
a longitude, a latitude, and a timestamp of the given trajectory point.

13. The electronic device according to claim 9, wherein the geographical environment feature of a given trajectory point comprises at least one of the following:
information about a building where the given trajectory point is located or information about a road where the given trajectory point is located.

14. The electronic device according to claim 11, wherein the sequence model comprises one of the following:
a gated recurrent unit (GRU), a long short-term memory (LSTM), or a bi-directional long short-term memory (BiLSTM).

15. The electronic device according to claim 9, wherein the status of a given trajectory point comprises at least one of the following:
an active stop state, a passive stop state, or a non-stop state of the given trajectory point.

16. An electronic device, comprising:
at least one processor; and
a memory communicatively connected to the at least one processor, wherein the memory stores instructions executable by the at least one processor, and when executed by the at least one processor, the instructions cause the at least one processor to perform the method according to claim 8.

17. A non-transitory computer-readable storage medium storing computer instructions, wherein the computer instructions, when executed by one or more processors, are used to cause a computer to perform the method according to claim 1.

18. A non-transitory computer-readable storage medium storing computer instructions, wherein the computer instructions, when executed by one or more processors, are used to cause a computer to perform the method according to claim 8.
